(19) United States
(12) Patent Application Publication
(10) Pub. No.: US 2003/0137519 A1
(43) Pub. Date: Jul. 24, 2003

(54) Method and apparatus to handle multiple requests to different memory agents

(76) Inventors: Rima M. Nazanda, Folsom, CA (US); Subramaniam Maiyuran, Gold River, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/051,008

(22) Filed: Jan. 22, 2002

(51) Int. Cl. G09G 5/39; G09G 5/36

(52) U.S. Cl. 345/531; 345/558

(57) ABSTRACT

A graphics device is provided that includes a mechanism to receive a plurality of data requests in a particular order, a multipurpose buffer mechanism to simultaneously monitor a status of the plurality of data requests, and a mechanism to output responses to the plurality of data requests in the particular order. The multipurpose buffer mechanism may include an age counter section and a buffer control section. The age counter section may include a plurality of shift registers each corresponding to a different operation regarding the plurality of data requests.

### FIELD

The present invention is related to the field of processors and memory. More particularly, the present invention is directed to a method and apparatus to handle multiple requests to different memory agents.

### BACKGROUND

The use of a cache memory with a processor is well known in the computer art. A primary purpose of utilizing cache memory is to bring the data closer to the processor in order for the processor to operate on that data. It is generally understood that memory devices closer to the processor operate faster than memory devices farther away on the data path from the processor. However, there is a cost trade-off in utilizing faster memory devices. The faster the data access, the higher the cost to store a bit of data. Accordingly, cache memory tends to be much smaller in storage capacity than main memory, but is faster in accessing the data.

A computer system may utilize one or more levels of cache memory. Allocation and de-allocation schemes implemented for the cache for various known computer systems are generally similar in practice. That is, data that is required by the processor is cached in the cache memory (or memories). If a cache miss occurs, then an allocation may be made at the entry indexed by the access. The access can be for loading data to the processor or storing data from the processor to memory. The cached information may be retained by the cache memory until it is no longer needed, made invalid or replaced by other data, in which instances the cache entry may be de-allocated.

Recently, there has been an increase in demand for processors to provide high performance graphics applications, especially three-dimensional graphics applications. The impetus behind the increase in demand is because graphics applications tend to cause the processor to move large amounts of data (e.g., display data) from cache and/or system memory to a display device. This data, for the most part, may be used once or at most only a few times.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 illustrates a block diagram of an example computer system having a graphics platform;

FIG. 2 illustrates a block diagram of an example computer system having a host chipset for providing a graphics platform;

FIG. 3 illustrates a block diagram of hardware to perform data requests/responses;

FIG. 4 illustrates a block diagram of hardware to perform data requests/responses according to an example embodiment of the present invention;

FIG. 5 illustrates a block diagram of a buffer mechanism according to an example embodiment of the present invention;

FIG. 6 illustrates a block diagram of hardware to perform data requests/responses according to an example embodiment of the present invention;

FIG. 7 illustrates a multi-purpose buffer according to an example embodiment of the present invention; and

FIGS. 8A-8F illustrates various states of the age counter of FIG. 7 according to an example embodiment of the present invention.

### DETAILED DESCRIPTION

In the following detailed description, like reference numerals and characters may be used to designate identical, corresponding or similar components in differing figure drawings. Well known power/ground connections to components may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements may be highly dependent upon the platform within which the present invention is to be implemented. That is, such specifics should be well within the purview of one skilled in the art. Where specific details (such as circuits) are set forth in order to describe example embodiments of the invention, it should be apparent to one skilled in the art that the invention can be practiced without, or with variation of, these specific details. Finally, it should be apparent that differing combinations of hard-wired circuitry and software instructions may be used to implement embodiments of the present invention. The present invention is not limited to any specific combination of hardware and/or software.

Embodiments of the present invention may be described with respect to a signal(s) and/or a signal line(s). These terminologies are intended to be interchangeable between each other and between the singular and the plural. Arrangements and embodiments may also utilize the terminology of hitting data in a memory device and missing data in a memory device. Hitting data generally means that the requested data is located within the memory device whereas missing data generally means that the requested data is not located within the memory device. While embodiments and arrangements may be described as relating to a cache of data, one skilled in the art would understand that other memory devices are also possible. Further, arrangements and embodiments may relate to data requests or responses to the requests. Requests and responses may also be referred to as operations. Further, embodiments and arrangements may be described with respect to a status (such as HIGH or LOW) of a bit. The description is merely one example as one skilled in the art would know that the status may be reversed (e.g. a LOW bit may correspond to a positive response and a HIGH bit may correspond to a negative response) by a change in logic.

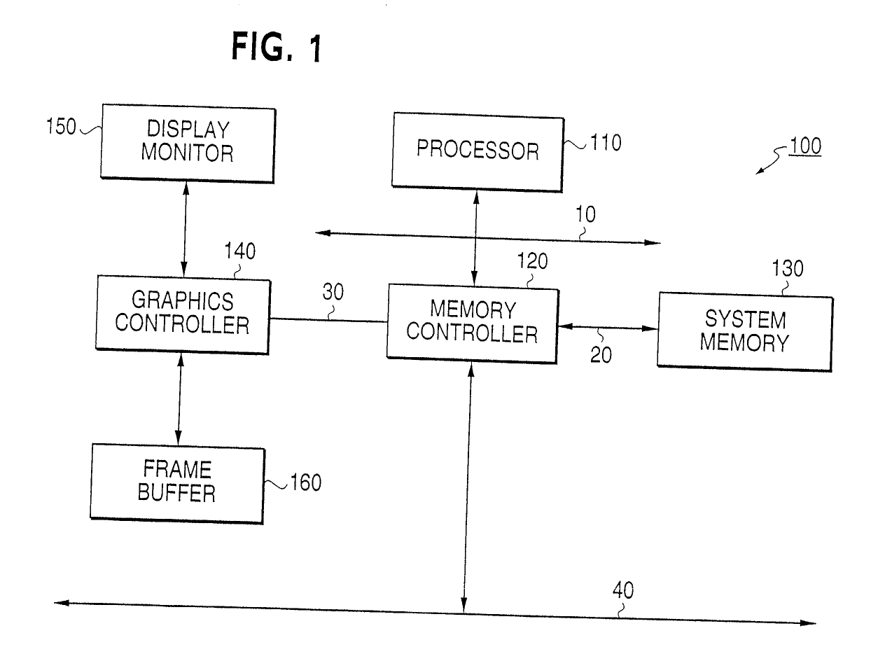

FIG. 1 illustrates an example computer system 100 having a graphics platform according to one arrangement. Other arrangements are also possible. The computer system 100 (which can be a system commonly referred to as a personal computer or PC) may include one or more processors or processing units 110 such as Intel® i386, i486, Celeron™ or Pentium® processors, a memory controller 120 coupled to the processing unit 110 via a front side bus 10, a system memory 130 coupled to the memory controller 120 via a memory bus 20, and a graphics controller 140 coupled to the memory controller 120 via a graphics bus (e.g., Advanced Graphics Port “AGP” bus) 30.

Alternatively, the graphics controller 140 may also be configured to access the memory controller 120 via a peripheral bus such as a peripheral component interconnect (PCI) bus 40 if so desired. The PCI bus 40 may be a high performance 32 or 64 bit synchronous bus with automatic configurability and multiplexed address, control and data lines as described in the latest version of “PCI Local Bus Specification, Revision 2.1” set forth by the PCI Special Interest Group (SIG) on Jun. 1, 1995 for added-on arrangements (e.g., expansion cards) with new video, networking, or disk memory storage capabilities. The graphics controller 140 may control a visual display of graphics and/or video images on a display monitor 150 (e.g., cathode ray tube, liquid crystal display and flat panel display). The display monitor 150 may be either an interlaced or progressive monitor, but typically is a progressive display device. A frame buffer 160 may be coupled to the graphics controller 140 for buffering the data from the graphics controller 140, the processing unit 110, or other devices within the computer system 100 for a visual display of video images on the display monitor 150.

The memory controller 120 and the graphics controller 140 may be integrated as a single graphics and memory controller hub (GMCH) including dedicated multi-media engines executing in parallel to deliver high performance 3D, 2D and motion compensation video capabilities, for example. The GMCH may be implemented as a PCI chip such as, for example, PIIX4® chip and PIIX6® chip manufactured by Intel Corporation. In addition, such a GMCH may also be implemented as part of a host chipset along with an I/O controller hub (ICH) and a firmware hub (FWH) as described, for example, in Intel® 810 and 8XX series chipsets.

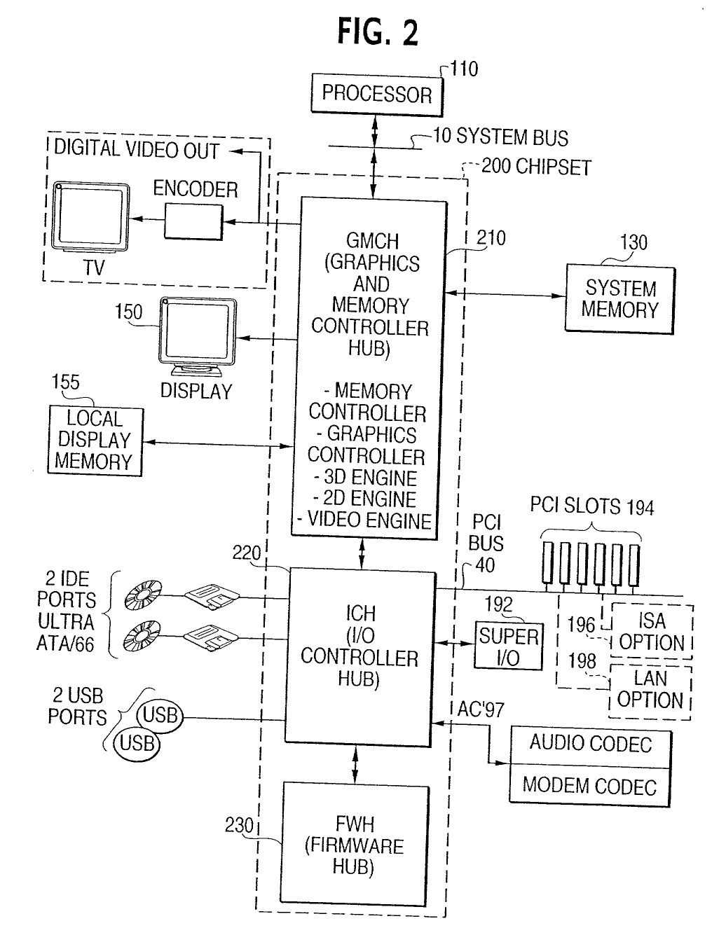

FIG. 2 illustrates the example computer system 100 including such a host chipset 200. As shown in FIG. 2, the computer system 100 includes essentially the same components shown in FIG. 1, except for the host chipset 200 that provides a highly-integrated three-chip solution including a graphics and memory controller hub (GMCH) 210, an input/output (I/O) controller hub (ICH) 220 and a firmware hub (FWH) 230.

The GMCH 210 may provide graphics and video functions and interfaces one or more memory devices to the system bus 10. The GMCH 210 may include a memory controller as well as a graphics controller (which in turn may include a 3D engine, a 2D engine, and a video engine). The GMCH 210 may be interconnected to any of the system memory 130, a local display memory 155, a display monitor 150 (e.g., a computer monitor) and to a television (TV) via an encoder and a digital video output signal. The GMCH 120 may be, for example, an Intel® 82810 chip or a 82810-DC100 chip. The GMCH 120 may also operate as a bridge or interface for communications or signals sent between the processor 110 and one or more I/O devices that may be connected to the ICH 220.

The ICH 220 may interface one or more I/O devices to the GMCH 210. The FWH 230 may be coupled to the ICH 220 and provide firmware for additional system control. The ICH 220 may be, for example, an Intel® 82801 chip and the FWH 230 may be, for example, an Intel® 82802 chip.

The ICH 220 may be coupled to a variety of I/O devices and the like such as: a Peripheral Component Interconnect (PCI) bus 40 (PCI Local Bus Specification Revision 2.2) that may have one or more I/O devices connected to PCI slots 194, an Industry Standard Architecture (ISA) bus option196 and a local area network (LAN) option 198; a Super I/O chip 192 for connection to a mouse, keyboard and other peripheral devices (not shown); an audio coder/decoder (Codec) and modem Codec; a plurality of Universal Serial Bus (USB) ports (USB Specification, Revision 1.0); and a plurality of Ultra/66 AT Attachment (ATA) 2 ports (X3T9.2 948D specification; commonly also known as Integrated Drive Electronics (IDE) ports) for receiving one or more magnetic hard disk drives or other I/O devices.

The USB ports and IDE ports may be used to provide an interface to a hard disk drive (HDD) and compact disk read-only-memory (CD-ROM). I/O devices and a flash memory (e.g., EPROM) may also be coupled to the ICH of the host chipset for extensive I/O support and functionality. Those I/O devices may include, for example, a keyboard controller for controlling operations of an alphanumeric keyboard, a cursor control device such as a mouse, track ball, touch pad, joystick, etc., a mass storage device such as magnetic tapes, hard disk drives (HDD), and floppy disk drives (FDD), and serial and parallel ports to printers and scanners. The flash memory may be coupled to the ICH of the host chipset via a low pin count (LDC) bus. The flash memory may store a set of system basic input/output start up (BIOS) routines at startup of the computer system 100. The super I/O chip 192 may provide an interface with another group of I/O devices.

Embodiments of the present invention may relate to a method and apparatus to dispatch multiple requests to different memory agents (such as cache and system memory). That is, a graphics engine may send a data request for desired data. If the requested data is not located within internal caches of the graphics engine, then the data requests may be dispatched to a main memory to retrieve the requested data. An additional level of cache (hereafter also called a level three cache) may be made available to the graphics engine without perturbing its original behavior in terms of software and validation. A multi-purpose buffer that maintains these properties may guarantee not only the memory ordering functionality but also confirms the expected processor performance levels.

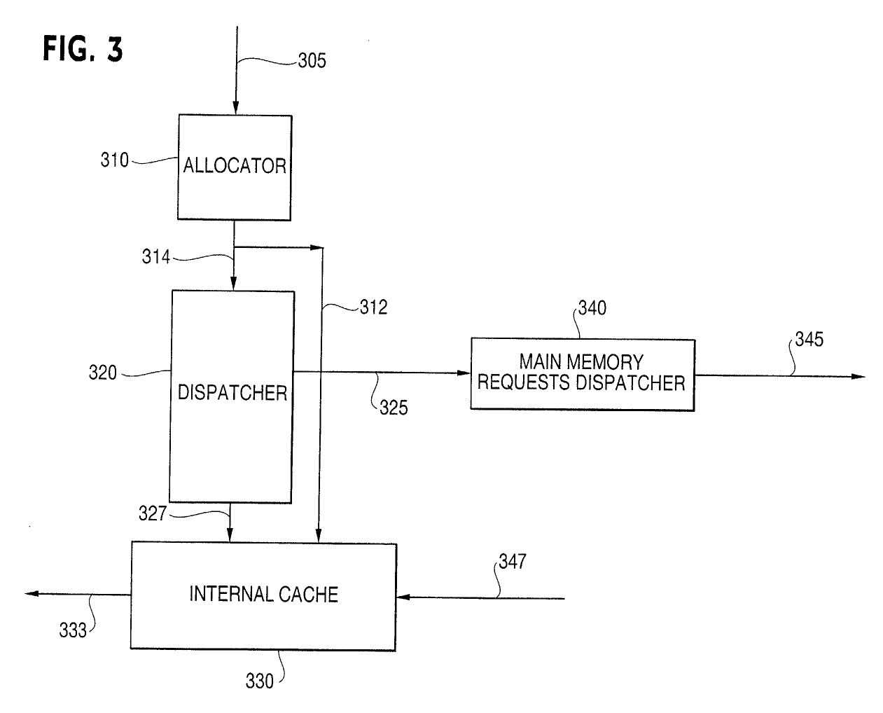

FIG. 3 illustrates an example arrangement of handling dispatches from a graphics engine. More specifically, FIG. 3 shows an in-order engine that includes an allocator 310, a dispatcher 320, internal cache 330 and a main memory requester 340. During operation, a graphics engine (not shown in FIG. 3) may send a dispatch (also hereafter called a data request) along a signal line 305 to the in-order engine that includes the allocator 310, the dispatcher 320 and the internal cache 330. The allocator 310, the dispatcher 320 and the internal cache 330 may all be provided within a graphics controller. The tag within the allocator 310 may determine if the requested data is in the internal cache 330 or whether the requested data is located within main memory (not shown in FIG. 3). The tag within the allocator 310 may contain logic that determines the location of the requested data. For example, if the requested data is located within the internal cache 330, then a dispatch may be sent along a signal line 312 to the internal cache 330. On the other hand, if the allocator 310 determines that the requested data is not located within the internal cache 330, then information relating to that request may be sent along a signal line 314 to the dispatcher 320.

The dispatcher 320 may act as a queue to maintain an order of requests. That is, the information stored in the dispatcher 320 may be the identification (ID) of the request. This ID may be matched up with the ID of the data coming back. This may be done so that the data coming back is matched up with the IDs and sent back to the graphics engine in the order it was requested. The dispatcher 320 may send a read request along a signal line 325 to the main memory request dispatcher 340. The main memory request dispatcher 345 may appropriately send a memory request along a signal line 345 to the main memory (such as the system memory 130 shown in FIG. 1). The main memory may return the requested data along a signal line 347 to the internal cache 330 where it may be stored. The dispatcher 320 may contain an ID queue to reference the appropriate location within the internal cache 330 by transmitting signal requests along a signal line 327. The requested data may be transmitted back to the graphics engine along a signal line 333.

In summary, FIG. 3 shows an in-order engine that may send dispatches to main memory to retrieve requested data. Any change in the operation mode may be detected and the caches may be flushed before the next request from the new operational mode comes to the cache.

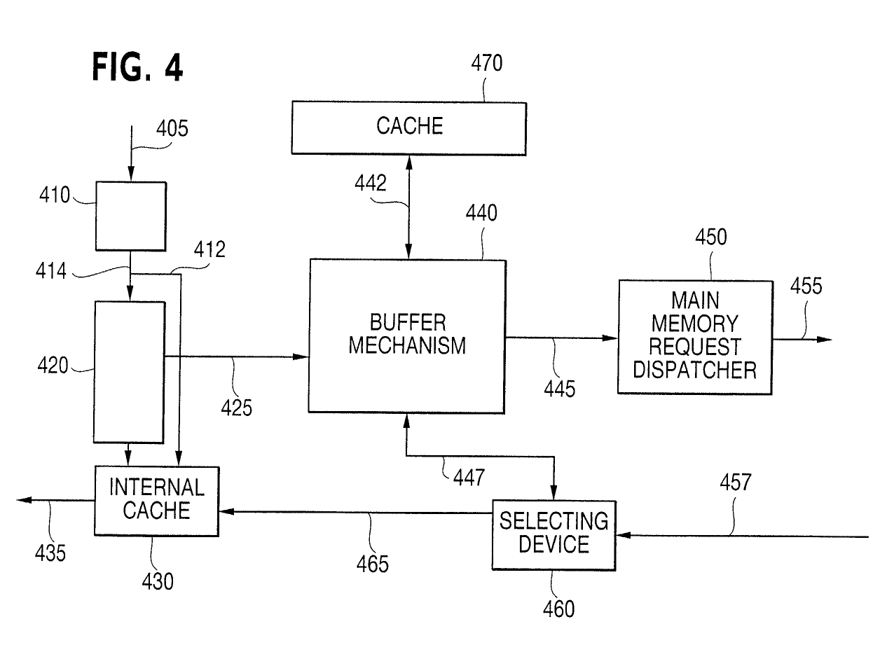

FIG. 4 illustrates a block diagram of hardware to handle data requests/responses according to an example embodiment of the present invention. Other embodiments and configurations are also within the scope of the present invention. More specifically, FIG. 4 shows an in-line engine that includes an allocator 410, a dispatcher 420, an internal cache 430, a buffer mechanism 440, a main memory request dispatcher 450, a selecting device 460 and a cache (hereafter also called a level three cache) 470. The allocator 410, the dispatcher 420 and the internal cache 430 may operate in a similar manner as the allocator 310, the dispatcher 320 and the internal cache 330 shown in FIG. 3. The allocator 410, the dispatcher 420 and the internal cache 430 may all be provided within a graphics controller to receive data requests from a graphics engine (not shown in FIG. 4).

During operation, the graphics engine may send a dispatch (hereafter also called a data request) along a signal line 405 to the allocator 410. The tag within the allocator 410 may determine if the requested data is in the internal cache 430 or whether the requested data is located within another memory device. If the requested data is located within the internal cache 430, then a dispatch may be sent along a signal line 412 to the internal cache 430. On the other hand, if the tag within the allocator 410 determines that the requested data is not located within the internal cache 430, then information relating to that request may be sent along a signal line 414 to the dispatcher 420. The dispatcher 420 may send a read request to the buffer mechanism 440 across a signal line 425. As will be discussed below, the buffer mechanism 440 may operate in cooperation with the other components to obtain the requested data from either the cache 470 or from the main memory (such as the system memory 130 shown in FIG. 1). That is, the buffer mechanism 440 may be coupled to the cache 470 by a signal line 442 so as to obtain data from (or place data within) the cache 470. The buffer mechanism 440 may also be coupled by a signal line (or signal lines) 447 to the selecting device 460 so as to transfer data between the two devices. The buffer mechanism 440 may also be coupled by a signal line 445 to the main memory request dispatcher 450. If the requested data is not with the cache 470, then the buffer mechanism 440 may communicate with the main memory request dispatcher 450 along the signal line 445. The main memory request dispatcher 450 may appropriately send a memory request along a signal line 455 to the main memory (such as the system memory 130 shown in FIG. 1). The main memory may return the requested data along a signal line 457 to the selecting device 460. The returned data may be appropriately stored in the internal cache 430 by passing the data through the selecting device 460 and along a signal line 465. The returned data may also be stored within the cache 470 through use of the selecting device 460. The requested data may be transmitted back to the graphics engine along a signal line 435.

In accordance with embodiments of the present invention, the buffer mechanism 440 may perform a plurality of functions simultaneously, substantially simultaneously or at different times. This allows the buffer mechanism 440 to handle multiple requests to a plurality of memory locations such as the cache 470 and the main memory. For example, the buffer mechanism 440 may perform the following functions: 1) the buffer mechanism 440 may receive requests from the dispatcher 420 across the signal line 425; 2) the buffer mechanism 440 may dispatch requests to the cache 470 to determine if the requested data is present in the cache 470; 3) the buffer mechanism 440 may receive the requested data (i.e., a data hit) or miss information from the cache 470; 4) the buffer mechanism 440 may schedule transactions that miss the cache 470 to the main memory across the signal line 455 that have a data miss from the cache 470; and 5) in case of a data hit to the cache 470, the buffer mechanism 440 may schedule cycles to the graphics engine so as to dispatch data back to the internal cache 430.

The buffer mechanism 440 may hold requests to a plurality of agents (such as the cache 470, a main memory request buffer and hit data for the engine from the cache 470). However, the requests are to be dispatched from the internal cache 430 to the graphics engine along the signal line 435 in the same order that the graphics engine requested the data (i.e., along the signal line 405). For example, requests relating to data misses to the cache 470 may be sent to the main memory in an order that the requests were received from the graphics engine. Additionally, responses relating to data hits to the cache 470 should return the data in the same order that the buffer mechanism 440 received the respective requests from the dispatcher 420. The requests to the cache 470 may need to be scheduled in the same order as the buffer mechanism 440 received them from the dispatcher 420.

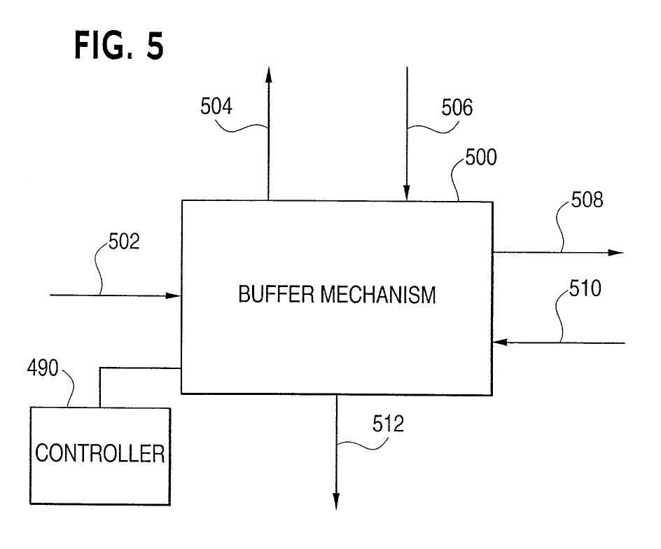

FIG. 5 illustrates a buffer mechanism 500 according to an example embodiment of the present invention. Other embodiments and configurations are also within the scope of the present invention. The buffer mechanism 500 may correspond to the buffer mechanism 440 shown in FIG. 4. FIG. 5 shows various operations that may need to be tracked by the buffer mechanism 500. The operations 502, 504, 506, 508, 510 and 512 correspond to requests/responses that may be transmitted along signal lines (such as signal lines 425, 442, 445 and 447 shown in FIG. 4) to and from the buffer mechanism 500. A controller 490 may control the respective operations of the buffer mechanism 500 as well as other components. More specifically, these operations correspond to requests/responses regarding memory in the internal cache 430, the cache 470 and the main memory (such as the system memory 130 shown in FIG. 1). The operation 502 may correspond to a request from a data miss at the internal cache 430. The operation 504 may correspond to a data request to the cache 470. The operation 506 may correspond to hit/miss information from the cache 470. The operation 508 may correspond to a request to the main memory. The operation 510 may correspond to a data response from the main memory and the operation 512 may correspond to data return to the internal cache 430. Other operations of the buffer mechanism 500 are also within the scope of the present invention.

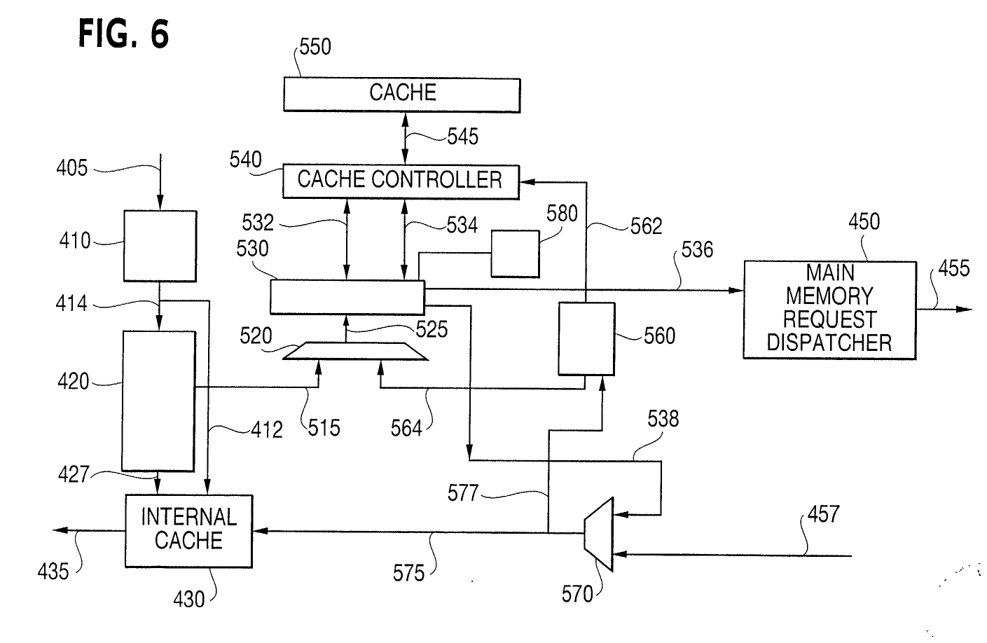

FIG. 6 illustrates a block diagram of hardware to handle data requests/responses according to an example embodiment of the present invention. Other embodiments and configurations are also within the scope of the present invention. More specifically, FIG. 6 shows the allocator 410, the dispatcher 420 and the internal cache 430 coupled together by the signal lines 412, 414 and 427 in a similar manner as shown in FIG. 4. FIG. 6 additionally shows the dispatcher 420 is coupled by a signal line 515 to one input of a selection device 520. The output of the selection device 520 is coupled by a signal line 525 to a multi-purpose buffer 530. The multi-purpose buffer 530 is coupled by signal lines 532 and 534 to a cache controller 540. The cache controller 540 is coupled by signal lines 545 to a cache 550 (which may correspond to the cache 470 of FIG. 4). FIG. 6 additionally shows a fill tracker 560 that is coupled by a signal line 562 to the cache controller 540 and is coupled by a signal line 564 to another input of the selection device 520.

FIG. 6 also shows that the multi-purpose buffer 530 may be coupled by a signal line 536 to the main memory request dispatcher 450. The main memory request dispatcher 450 may appropriately send a memory request along the signal line 455 to the main memory (such as the system memory 130 shown in FIG. 1). The main memory may return the requested data along the signal line 457 to an input of a selection device 570. The selection device 570 may also receive data along a signal line 538 from the multi-purpose buffer 530. This data may have been obtained from the cache 550, for example. The selection device 570 may output the requested data along the signal line 575 to the internal cache 430. The selection device 570 may output the requested data along a signal line 577 to the fill tracker 560. The fill tracker 560 may appropriately send the data to the cache controller 540 along the signal line 562 and ultimately to the cache 550 where the data may be locally stored. As discussed above, data returned from the main memory may be stored within caches (such as the cache 550 or the internal cache 430) closer to the graphics engine than the main memory (such as the system memory 130 shown in FIG. 1).

The circuitry shown in FIG. 6 illustrates details of the buffer mechanism 440 shown in FIG. 4. The circuitry of FIG. 6 performs the respective functions and operations discussed above with respect to FIG. 4. That is, the circuitry shown in FIG. 6 may simultaneously (or substantially simultaneously) perform various functions such as: 1) the multi-purpose buffer 530 may receive requests from the dispatcher 420; 2) the multi-purpose buffer 530 may dispatch requests to the cache 550 to determine if the requested data is present in the cache 550; 3) the multi-purpose buffer 530 may receive the requested data or may receive miss information from the cache 550; 4) the multi-purpose buffer 530 may schedule transactions that miss the cache 550 to the main memory; and 5) the multi-purpose buffer 530 may schedule cycles to the graphics engine so as to dispatch the data back to the internal cache 430.

The dispatcher 420 may send a request along the signal line 515 to the selection device 520 that may pass the information to the multi-purpose buffer 530. The multi-purpose buffer 530 may send requests to the cache controller 540 along the signal line 532 and to the cache 550 along the signal line 545. Data from the cache 550 may pass along the signal line 545 to the cache controller 540 and along the signal line 534 to the multi-purpose buffer 530. Data from the cache 550 may be temporarily stored in the multi-purpose buffer 530 and may pass along the signal line 538 to the selection device 570. This data may pass through the selection device 570 and along the signal line 575 to the internal cache 430. Data from the main memory may also pass through the selection device 570 and along the signal line 577 to the fill tracker 560. This data from the main memory may pass along the signal line 562 to the cache controller 540 and ultimately to the cache 550.

In order to simultaneously perform the various operations of the multi-purpose buffer 530, a controller 580 may be coupled to the multi-purpose buffer 530 to manage operations of different requests and responses to the multi-purpose buffer 530. As stated above, data requests may arrive from a graphics engine in a particular order along the signal line 405. Data regarding these requests should be returned back to the graphics engine in a similar order along the signal line 435. Accordingly, the multi-purpose buffer 530 (and the controller 580) may include a mechanism to identify a particular request (or a particular operation) and to identify an age of that request. The age of the operation (or request) may be used to determine an order of operations by the multi-purpose buffer 530. That is, an age mechanism within the multi-purpose buffer 530 may be used to determine an order of requests/responses to and from multiple memory elements.

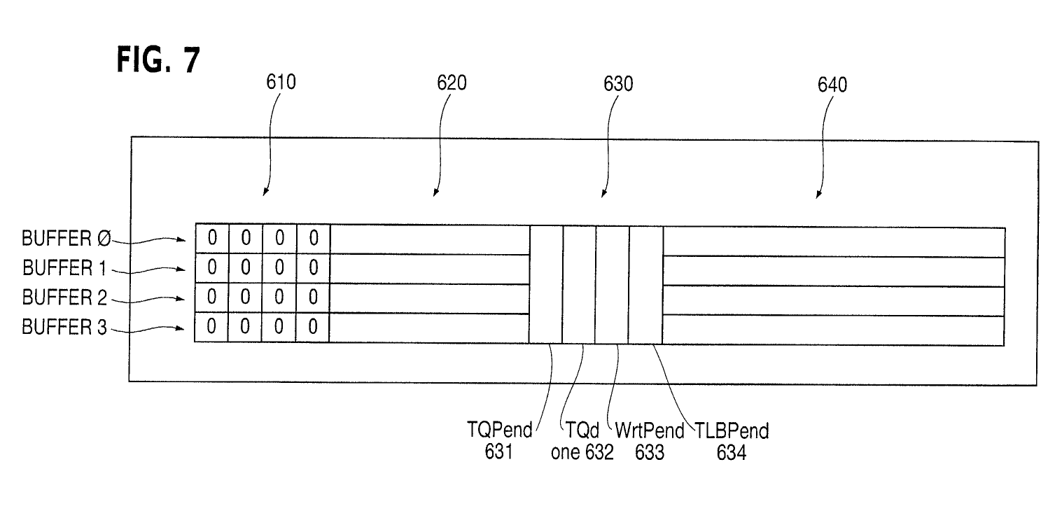

FIG. 7 illustrates one structure of the multi-purpose buffer 530 (shown in FIG. 6) according to an example embodiment of the present invention. Other embodiments and configurations of the multi-purpose buffer 530 are also within the scope of the present invention. The multi-purpose buffer 530 may include four sections, namely an age counter section 610, a linear address section 620, a buffer control section 630 (containing control bits), and a pass-thru information section 640. The multi-purpose buffer 530 may identify a category (such as an operation based on the control bits) as well as an age of an operation. This may be done to determine which operation to perform/send next. This may ensure that the requests are sent back to the graphics engine in the same order that the requests were received.

The age counter section 610 may correspond to a four-by-four shift register that shifts bits (either a “1” bit or a “0” bit) from the right to the left for a request (also hereafter called an allocation) as will be discussed below. The age counter section 610 may be used to determine an age (or order) of each of the respective operations identified in the multi-purpose buffer 530. That is, a “1” bit (or HIGH bit) may correspond to a particular operation whereas a “0” bit (or LOW bit) may correspond to an empty or negative condition. For illustration purposes, the top row may hereafter be referred to as Buffer 0, the second row from the top may hereafter be referred to as Buffer 1, the third row from the top may hereafter be referred to as Buffer 2 and the bottom row may hereafter be referred to as Buffer 3. Each of the Buffers 0-3 may act as a one-level shift register that shifts from the right to the left for each new entry (or each allocation). Each of the rows (or buffers) of the age counter section 610 may correspond to a particular operation (such as various operations of the multi-purpose buffer 530). Because the shift registers shift from right to left for each allocation, the row (or buffer) having a HIGH bit (or “1” bit) closest to the left may be considered the oldest bit within the age counter section 610. This may thereby identify the oldest operation in the multi-purpose buffer 530. Although not specifically described in detail, embodiments of the present invention are also applicable to shift registers that shift from the left to the right. In such an embodiment, the row (or buffer) having a HIGH bit closest to the right may be considered the oldest bit within the multi-purpose buffer 530. This may thereby identify the oldest operation in the multi-purpose buffer 530.

The linear address section 620 may contain addresses regarding the respective operations of the multi-purpose buffer 530. FIG. 7 shows four rows of data in the linear address section 620. Each row corresponds with an adjacent shift register row in the age counter section 610. The linear address section 620 may contain the address of the requested data. The address in the top row of the linear address section 620 corresponds to the operation identified in Buffer 0, the address in the second row from the top of the linear address section 620 corresponds to the operation identified in Buffer 1, the address in the third row from the top of the linear address section 620 corresponds to the operation identified in Buffer 2, and the address in the bottom row of the linear address section 620 corresponds to the operation identified in Buffer 3. The addresses within the linear address section 620 may be used to access the requested data. The address may be used in the cache 550 to match against so as to determine if this location is saved in this level of cache. If it is not, then the address may be sent on to the external memory (such as the system memory 130) to fetch the data.

The buffer control section 630 may contain a pointer (or control bit) to represent different operations of the multi-purpose buffer 530. While FIG. 7 only shows four respective operations (TQPend, TQdone, WrtPend and TLBPend), the multi-purpose buffer 530 may be expanded or decreased to include either more or less operations. More specifically, the buffer control section 630 may include: 1) a TQPend section 631; 2) a TQdone section 632; 3) a WrtPend section 633; and 4) a TLBPend section 634. While FIG. 7 shows each section as a column, each section may include a status bit (also called control bit) for each corresponding row (or Buffer) of the age counter section 610. Stated differently, the TQPend section 631 may include: (1) a bit indicating a status for Buffer 0 (i.e., the top row of the age counter section 610); (2) a bit indicating a status for Buffer 1 (i.e., the second row from the top of the age counter section 610); (3) a bit indicating a status for Buffer 2 (i.e., the third row from the top of the age counter section 610); and (4) a bit indicating a status for Buffer 3 (i.e., the bottom row of the age counter section 610). Each of the other sections 632, 633 and 634 may also include multiple bits indicating the status for each of the Buffers 0-3. A HIGH bit (or “1” bit) may indicate that a specific operation corresponds to one of the Buffers 0-3 and a LOW bit (or “0” bit) may indicate an empty or negative condition for each of the Buffers 0-3.

The buffer control section 630 may be used to identify the status of various operations surrounding the multi-purpose buffer 530. TQPend may indicate that a request was sent to the cache 550 and the multi-purpose buffer 530 is waiting for a response form the cache 550. TQdone may indicate hit or miss information from the cache 550. WrtPend may indicate a hit on the data in the cache 550 and an indication that the data is being sent back to the internal cache 430. TLBPend may indicate a miss at the cache 550 and an indication that the request is being sent to the main memory. Other operations for each of the sections of the buffer control section 630 are also within the scope of the present invention.

The pass-thru section 640 may contain information for the receiving unit and that is passive to the intermediate units. The information may be related to the graphical configuration of the fetched data.

Embodiments of the present invention will now be explained with respect to the multi-purpose buffer 530 and more particularly with respect to the age counter section 610 and the buffer control section 630. At reset or initialization of the multi-purpose buffer 530, all entries (i.e., bits) of the age counter section 610 may be cleared. That is, all the bits may be set to “0” (where “0” represents an empty condition). A pointer that identifies the next location to be allocated (hereafter referred to as the allocation pointer) may identify the top row of the buffer (hereafter also called Buffer 0) as the next row to identify an operation.

Queue full and queue empty conditions may be tested by examining the age counter bits within the age counter section 610. The age counter bits may be logically used to indicate whether an entry in the buffer (such as Buffer 0) is valid or not. If an entire row of the age counter section 610 contains all “0” bits then that row may represent an empty condition meaning that the multi-purpose buffer 530 does not have a corresponding operation for that row. If a row of the age counter section 610 contains a “1” bit then that row may have a corresponding operation (that may be determined by the buffer control section 630).

Since the multi-purpose buffer 530 dispatches to three different location (i.e., the cache 550, the main memory and the data returned as a result of a hit to the cache 550), the multi-purpose buffer 530 may utilize three pointers to keep track of which entry is next to be dispatched to which destination. These pointers are provided within the buffer control section 630. The pointers may perform the following: 1) issue the next request to the cache 550 (i.e., identified in the TQPend section 631); 2) issue the next request to the main memory (i.e., identified in the TLBPend section 631); and 3) issue the next request to dispatch data back to the requesting engine as a result of a hit on the cache 550 (i.e., the WrtPend section 633). The oldest valid condition may be tested before a request is made. For the requests dispatching to the cache 550, the requests may be sent from the multi-purpose buffer 530 in the order that they were received from the graphics engine. For the data returning as a result of a hit on the cache 550, the data may be delivered in the same order that the cache 550 responds.

Data that is found to be a hit by the cache 550 may be forwarded back to the graphics engine from the cache 550. The multi-purpose buffer 530 may include registers for temporarily storing data as the data passes to the requesting engine directly from the cache 550. These registers may be bypassed, in which case the data may be delivered from the cache 550.

When a request is made to the main memory or back to the requesting engine, and it is acknowledged, then the entry (i.e., the bits in the respective row) in the multi-purpose buffer 530 may be de-allocated. When an entry is de-allocated from the queue, then the corresponding age counter entry may be cleared (i.e., reset to zero) and the buffer location may be free to be allocated.

When an entry is allocated to the multi-purpose buffer 530, then select counters of the buffers may be shifted (to indicate that they are older) based on a previous de-allocation condition.

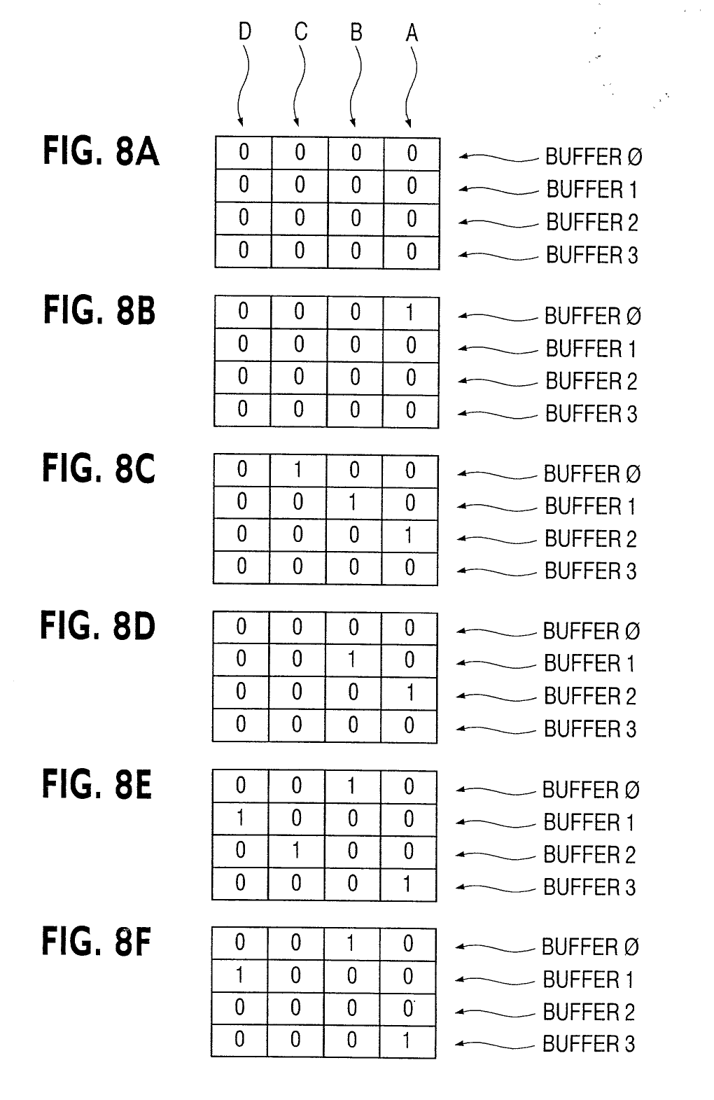

FIGS. 8A-8F illustrate various states of the age counter section 610 according to an example embodiment of the present invention. Other embodiments and configurations are also within the scope of the present invention. For ease of illustration, the columns are labeled A, B, C and D to help identify bits. Additionally, the respective allocations may be sequentially numbered as Allocation #1, Allocation #2, Allocation #3 and Allocation #4. As discussed above, it is important that the apparatus be able to determine the order of operations in order to properly time (or order) the data request. The age counter section 610 may be used to appropriately time or order the respective operations. In this example embodiment, the age counter section 610 includes a bit of “1” when the respective buffer identifies a particular data operation (that may be specifically identified in the buffer control section 630). The age counter section 610 includes a bit of “0” when the respective buffer does not identify a specific operation (i.e., an empty queue or buffer).

FIG. 8A shows all of the entries are cleared as all the bits are “0” in each of the respective Buffers 0-3. After an initial request is made to the multi-purpose buffer 530 (such as operation 502 in FIG. 5), then the request may be allocated into Buffer 0 in column A. That is, Buffer 0 contains a bit “1” in column A to identify Allocation #1. This bit corresponds to an operation that may be identified in the buffer control section 630. In accordance with at least one embodiment of the present invention, any future allocations may shift the bits in each of the columns to the left. That is, in a subsequent allocation, the bits in column A may shift to column B, the bits in column B may shift to column C and the bits in column C may shift to column D. This corresponds to the operation of a shift register that shifts right to left as discussed above.

FIG. 8C shows the age control section 610 after two subsequent allocations (namely after Allocation #2 and Allocation #3) have occurred. That is, the original allocation in Buffer 0 (at column A) has been shifted to the left twice and is now located in column C. Allocation #2 is initially identified in Buffer 1, column A. However, when the subsequent allocation (namely Allocation #3) occurs, then the bit in Buffer 1, column A is shifted to the left and becomes located in column B. Thus, Allocation #3 is identified by a bit “1” at Buffer 2, column A. That is, FIG. 8C shows the age counter after shifting twice (from the age counter in FIG. 8B). As indicated above, the ages (or orders) of the operations may be identified based on how far a “1” bit is to the left. The oldest operation within the age counter may be identified by the bit that is furthest to the left. In FIG. 8C, the operation associated with Buffer 0 (in column C) may be considered the oldest operation, the operation associated with Buffer 1 (in column B) is the next oldest operation, and the operation associated with Buffer 2 (in column A) is the last operation identified in the age counter.

FIG. 8D shows the age counter section 610 after deallocation of the first request. Deallocation clears the counter. That is, FIG. 8D shows that the bit “1” in the Buffer 0, column C position has been cleared to a “0” bit, Accordingly, the oldest operation within the age counter is now identified by the bit at Buffer 1, column B and the only other operation identified in the age counter is identified by the bit at Buffer 2, column A.

FIG. 8E shows the age counter section 610 after two subsequent allocations (namely Allocation #4 and Allocation #5). Allocation #4 may be associated with Buffer 0 and Allocation #5 may be associated with Buffer 3. The two allocations each cause the shifting of the bits to the left. Accordingly, the bit at Buffer 1, column B is shifted to column D, the bit at Buffer 2, column A is shifted to column C. Thus, Buffer 0 contains a bit “1” in column B and Buffer 3 contains a bit “1” in column A. Accordingly, the oldest operation within the age counter is now identified by the bit at Buffer 1, column D, the second oldest operation within the age counter is identified by the bit at Buffer 2, column C, and the third oldest operation within the age counter is identified by the bit at Buffer 0, column B.

FIG. 8F shows the age counter section 610 after the deallocation of the operation associated with Buffer 2. That is, FIG. 8F shows that the bit “1” in the Buffer 2, column C position has been cleared to a “0” bit. Accordingly, while the oldest operation within the age counter still corresponds to the operation at Buffer 1, column D, the next oldest operation within the age counter corresponds to the operation associated with Buffer 0, column B and the third oldest operation corresponds to the operation associated with Buffer 3, column A.

The above operations described with respect to FIGS. 8A-8F are merely one example embodiment of the present invention. Other orders of allocation and deallocation are also within the scope of the present invention.

Embodiments of the present invention may include a mechanism to determine the age of the various operations (or dispatches) stored within the multi-purpose buffer 530. This mechanism may include logic circuits and/or use of the controller to perform age determination of the respective bits within the age counter section 610. The mechanism may include logic to determine which row (or which one of the Buffers 0-3) of the multi-purpose buffer 530 is identified with a respective operation. For example, in the age counter section shown in FIG. 8F, each of Buffers 0, 1 and 3 is identified with a respective operation (based on the control bits within the buffer control section 630). The mechanism may also include logic to examine each of the columns (such as A-D) of the age counter section 610 and to specifically identify the leftmost bit from the vertical columns. This may be done using one or a plurality of masks, for example. In the example of FIG. 8F, the ages of each of the Buffers may be identified as follows: Buffer0Age=[0010]; Buffer1Age=[1000]; Buffer2Age=[0000]; and Buffer3Age=[0001]. The mechanism may identify Buffer1Age as having the leftmost HIGH bit by use of a mask such as [1000]. This thereby identifies the oldest operation of the multi-purpose buffer 530. The respective operation or dispatch may thereafter be performed by use of the multi-purpose buffer 530 and the controller 490. Other methods and means for identifying the oldest dispatch or operation within the age counter section 631 are also within the scope of the present invention.

It may be desirable to make the mechanism only relevant to a specific dispatch (or operation). For example, it may only be desirable to examine operations corresponding to TQPend (based on the control bits within the buffer control section 630). The mechanism may operate to only examine those operations within the age counter section 610 that correspond to a TQPend operation. This may avoid the logic from examining operations other than ones that correspond to the TQPend operation.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A graphics device comprising:
a mechanism to receive a plurality of data requests in a particular order;
a multipurpose buffer mechanism to simultaneously monitor a status of said plurality of data requests; and
a mechanism to output responses to said plurality of data requests in said particular order.

2. The graphics device of claim 1, wherein said multipurpose buffer mechanism maintains information regarding said plurality of data requests to a plurality of memory locations.

3. The graphics device of claim 1, wherein said multipurpose buffer mechanism comprises an age counter section and a buffer control section.

4. The graphics device of claim 3, wherein said age counter section comprises a plurality of shift registers each corresponding to one of said plurality of data requests.

5. The graphics device of claim 3, wherein said buffer control section identifies a status of each of said plurality of data requests.

6. The graphics device of claim 3, wherein said multipurpose buffer mechanism determines an age of said plurality of data requests stored in said multipurpose buffer mechanism.

7. The graphics device of claim 6, wherein said age is determined based on said age counter section.

8. A system to process a plurality of data requests, said system comprising:
a plurality of memory locations each to store data; and
a multipurpose buffer mechanism to maintain an ordering of said data requests to said plurality of memory locations and data responses from said plurality of memory locations.

9. The system of claim 8, wherein said multipurpose buffer mechanism simultaneously maintains information regarding said plurality of data requests.

10. The system of claim 8, wherein said multipurpose buffer mechanism comprises an age counter section and a buffer control section.

11. The system of claim 10, wherein said age counter section comprises a plurality of shift registers each corresponding to a different one of said plurality of data requests.

12. The system of claim 10, wherein said buffer control section identifies a status of each of said plurality of data requests.

13. The system of claim 10, wherein said multipurpose buffer mechanism determines an age of said plurality of data requests in said multipurpose buffer mechanism.

14. The system of claim 13, wherein said age is determined based on said age counter section.

15. A computer graphics system comprising a device to handle a plurality of graphics data requests to different memory agents based on an age mechanism.

16. The computer graphics system of claim 15, wherein said plurality of data requests are received from a graphics engine.

17. The computer graphics system of claim 16, wherein said device comprises a multipurpose buffer mechanism that maintains an order of said data requests to said different memory agents when providing responses back to said graphics engine.

18. The computer graphics system of claim 17, wherein said multipurpose buffer mechanism simultaneously maintains information regarding said plurality of data requests.

19. The computer graphics system of claim 17, wherein said multipurpose buffer mechanism comprises an age counter section corresponding to said age mechanism and a buffer control section.

20. The computer graphics system of claim 19, wherein said age counter section comprises a plurality of shift registers each corresponding to a different one of said plurality of data requests.

21. The computer graphics system of claim 19, wherein said buffer control section identifies a status of each of said plurality of data requests.

22. The computer graphics system of claim 19, wherein said multipurpose buffer mechanism determines an age of operations stored in said multipurpose buffer mechanism.

23. The computer graphics system of claim 22, wherein said age is determined based on said age counter section.

24. A method of obtaining data for a graphics engine comprising:
receiving a plurality of data requests in a particular order;
obtaining data regarding said plurality of data requests from a plurality of memory devices; and
returning responses of said plurality of data request to said graphics engine in said particular order.

25. The method of claim 24, wherein obtaining said data comprises monitoring a status of a plurality of operations regarding said plurality of data requests.

26. The method of claim 24, wherein obtaining said data comprises maintaining an age counter for said plurality of data requests.

27. The method of claim 26, wherein obtaining said data further comprising determining an oldest age for said plurality of data requests.

28. A method comprising:
receiving a plurality of data requests from a graphics engine;
simultaneously monitoring a status of each of said data requests to a plurality of memory locations; and
returning data to said graphics engine from said plurality of memory locations.

29. The method of claim 28, wherein simultaneously monitoring comprises utilizing an age counter mechanism for said plurality of data requests.

30. The method of claim 29, wherein utilizing said age counter mechanism comprises determining an oldest age for said plurality of data requests.

31. The method of claim 30, wherein utilizing said age counter mechanism further comprises performing said one of said plurality of requests based on said determined oldest age.
